(19) United States
(12) Patent Application Publication
(10) Pub. No.: US 2006/0098008 A1
(43) Pub. Date: May 11, 2006

(54) Method, device and computer program product for generating a three-dimensional model

(76) Inventor: Christof Holberg, Iffeldorf (DE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/516,882

(22) PCT Filed: Jun. 3, 2003
(86) PCT No.: PCT/EP03/05795

§ 371 Date: Sep. 12, 2005

(30) Foreign Application Priority Data
Jun. 4, 2002 (DE) 102 24 735.8

(51) Int. Cl. G06T 17/00

(52) U.S. Cl. 345/420

(57) ABSTRACT

To create a three-dimensional model for a tangible existing object, the object in question is first digitized to generate a network model of the object. The network model is then divided into bilinear surface elements, which are finally reunited to form a surface or volume model. A finite element model can be created from said surface or volume model by CAD/FEM coupling. The generated models are not only accurate, but also their creation requires a relatively short computational time.

The invention relates to a method, an apparatus and a software product for creating a three-dimensional model for a tangible existing object, in particular for creating a surface model or solid model or an FE model (FE: Finite Element) from digitized data of the object.

In several technical fields there is a strong demand for converting the image of a tangible existing object into a computer model as real as possible. While simple objects can mostly be reconstructed quite well by means of CAD programs (CAD: Computer Aided Design), FE programs or the like, this is increasingly difficult in case of complex structures.

The discrepancy between demand and what is really possible is particularly evident in biotechnology, for instance, when the highly complex shape of anatomical structures is to be modeled. The geometrical or morphological inaccuracies of the model come in to bear especially when, based on the model, an FE analysis is to be carried out for calculating the physical behavior of the object.

In case of creating an FE model consisting of nodes and elements, there are in principle two different methods of creating the FE model, i.e. a direct and an indirect method. In the direct method, fixed nodes are provided to the FE program, and in the indirect method it is the FE program which selects the nodes from given geometrical elements (e.g. surface models or solid models, lines or points).

Upon studying the FE models which have been generated in biotechnology so far, it will be noted that most of the proposed methods are direct methods in which fixed nodes are provided to the FE program.

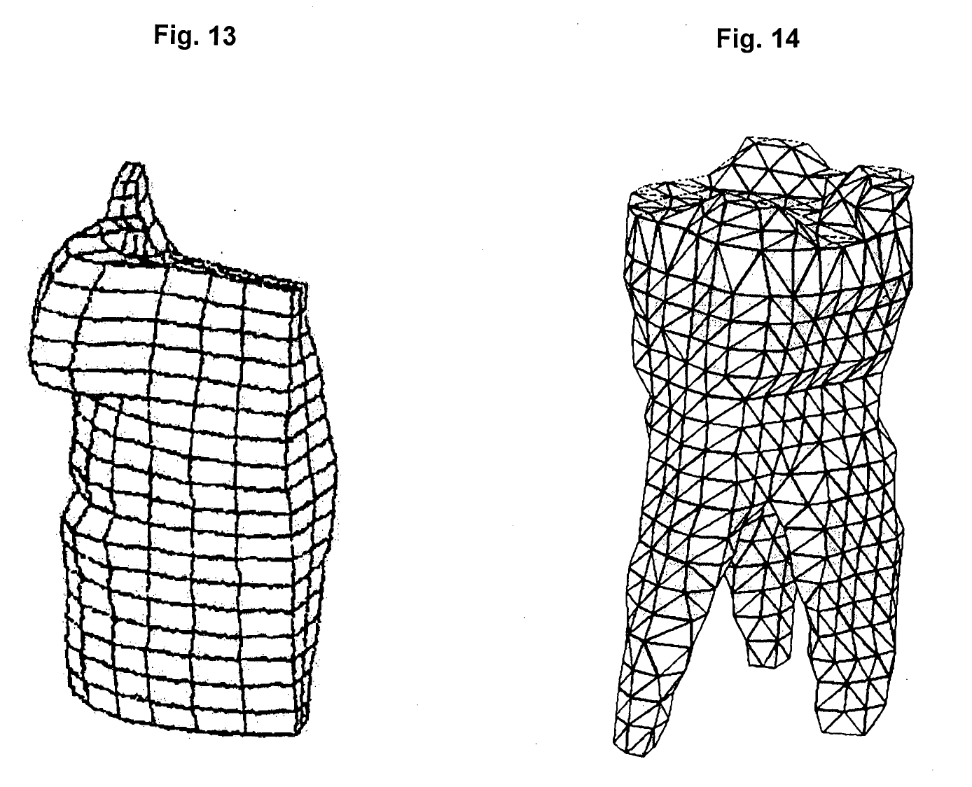

FIG. 13 shows an example of a directly constructed FE model of facial soft tissue as disclosed by Motoyoshi M. et al. in “Finite element model of facial soft tissue. Effects of thickness and stiffness on changes following simulation of orthognathic surgery.”, J Nihon Univ Sch Dent 35, 118-123 (1993). This method does without a morphologically exact conversion of the object structure into the virtual space and makes the attempt to reproduce the complexity of the structure as well as possible by manual reconstruction.

FE models may also be created by linking layers. In this case the geometrical data of the object is obtained by tomographic methods or preparing histologic sections.

For carrying out a point-based linking of layers, the tomograms obtained are digitized and the borders of the structure in question are identified. Then, nodes are defined on the boundaries of each layer to be first linked two-dimensionally in the respective layer and then three-dimensionally between the individual layers. FIG. 14 shows an FE model of a tooth obtained by such a point-based linking of layers, as disclosed by Lin C. et al. in “Automatic finite element mesh generation for maxillary second premolar.”, Comput Methods Programs Biomed 59, 187-195 (1994).

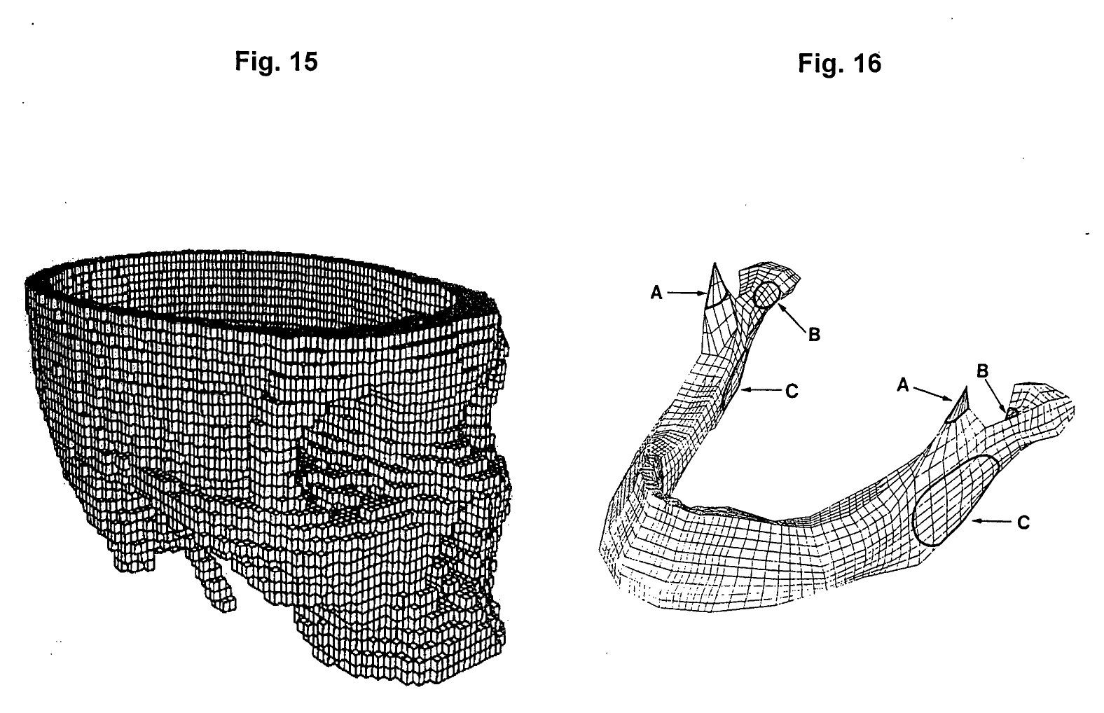

The linking of layers may also be carried out on the basis of voxels. For this purpose a defined square grid is laid over each tomogram obtained and a cubic element is assigned to each square corresponding to a voxel in the layer. Each element in a lower layer, which is not covered to a certain extend by the structure in question, is omitted. The remainder are layers made of uniform elements which, as piled up, constitute a three-dimensional FE model made of cubic elements. FIG. 15 shows such an FE model of the human skull obtained by a voxel-based linking of layers, as disclosed by Camacho D. et al. in “An improved method for finite element mesh generation of geometrically complex structures with application to the skullbase.”, J Biomech 30, 1067-1070 (1997).

A somewhat different approach was chosen by van Zyl P. et al. in “Three-Dimensional finite element of a human mandible incorporating six osseointegrated implants for stress analysis of mandibular cantilever prostheses.”, Int J Oral Maxillofac Implants 10, 51-57 (1992). An FE model of a lower jaw as shown in FIG. 16 was created by three-dimensionally linking a point cloud obtained from reflection-type micrographs. The point cloud was directly input into an FE program, with the points of the point cloud being used as nodes for the FE model. The automatic linking of the nodes, however, is not particularly reliable. Common FE programs frequently have difficulties in linking point clouds with different densities, so that usually special programs have to be used for three-dimensionally linking a point cloud. As these programs are not compatible with standard FE programs, the results are isolated solutions on the software side, which can only be handled by a skilled person.

Indirect methods for creating an FE model have been successful mainly in engineering. In the indirect methods, user-defined geometrical elements are provided to the FE program for automatically calculating the position of the nodes, wherein the geometrical elements define only the periphery and boundary of the FE model further on. The geometrical elements are either generated in the FE program or imported as surface models or solid models through so-called CAD-FEM coupling from a CAD program.

For creating the FE model indirectly, there are two alternative methods of generating the coordinates of the nodes: In case of so-called “mapped meshing”, nodes are determined to form quandrangular elements or hexahedrons. In case of “free meshing”, triangular elements or tetrahedrons having intermediate nodes (so-called parabolic elements) are formed which fit particularly well with complex geometries.

What matters is that, in the indirect method, it is usually necessary to manually construct the geometrical elements to be provided to the FE program in the FE program or in a CAD program. In engineering, this is not a disadvantage because most products are designed by means of a CAD program. In biotechnology, however, the indirect method has not been successful with a few exceptions such as in the evaluation of artificial structured parts such as hip prostheses and the like. The inaccuracies that occur when a tangible object is reproduced by direct construction are simply too large.

Up to date the only solution for converting the image of a tangible existing object into a format available to CAD-FEM coupling is reverse engineering. In reverse engineering, the object is digitized and CAD surfaces are created by surface reconstruction, which may be imported into an FE program. The CAD surfaces are usually comprised of freeform Bezier or NURBS patches (NURBS: non-uniform rational B-spline surface) which are fit piece by piece by means of a net of control nodes to the surface shape of the object. NURBS patches are usually at least bicubic parametric surface elements each of which approximates the object surface with two polynomial curves of third order. Solving the set of linear equations causes the more trouble the higher the order of the polynomials is, but achieves a more exact fit of the surface elements to the surface shape of the object. Due to the complicated algorithm used for surface reconstruction, reverse engineering software has been very expensive so far. Moreover, the calculations are highly time-consuming.

Besides, it was found that the fit of Bezier or NURBS patches to the surface shape of a geometrically complex structure is often inaccurate and that frequently irregular CAD surfaces are generated which can not be processed with CAD programs or FE programs.

The object of the invention is to provide a method, an apparatus and a software product which are capable of creating an accurate three-dimensional model of a tangible existing object with relatively low computing effort.

The above object is achieved by a method according to claim 1, an apparatus according to claim 6 and a software product according to claim 9.

The invention is characterized by first digitizing the object in question to create a mesh model of the object, then breaking the mesh model into bilinear surface elements and finally uniting the bilinear surface elements to a surface model or solid model.

By the term “mesh model”, polyface meshes, surface meshes or polygon meshes are understood, which are typically comprised of a finite number of polygons, wherein two vertices or nodes define one edge at a time and a plurality of such edges describes a geometrical body. The geometrical description of the body is effected in the mesh model in a purely numerical way. That is, in contrast to an analytic approach the geometric shape is not defined by mathematical equations, but purely by the location and density of the vertices or nodes.

With such meshes being described in a purely numerical way, the meshes can be created by digitizing the object. Digitizing may be carried out in different ways. For example, the object may be scanned optically or by contact to create a point cloud describing the object surface. This point cloud is used for generating the nodes for the mesh representation. Alternatively, surface images or tomograms are made of the object to be digitized. Using these images, the boundaries of the object are identified and individual points of the boundaries are used as nodes for the mesh representation.

Up to now it has been acted on the assumption that the numerical data of such mesh models cannot be used offhand for creating a surface model or solid model described by analytic functions. For example, a warning can be found in the German instruction manual of AutoCAD 2000™, page 719 according to which CAD programs can convert solids into surface meshes, but not surface meshes into solids. For converting the numerical data into analytic data, it was necessary so far to take the troublesome line of reverse engineering which is not always successful, in particular when dealing with complex geometries.

The invention bridges the numerical and the analytic description of object data by breaking the numerical data of the mesh model into the analytic data of bilinear surface elements.

By the term “bilinear surface element”, a surface patch defined by two polynomial curves of first order or two straight lines is understood. The end points of the straight lines are given by the nodes of the mesh. The two straight lines of each surface element form two edges of a polygon course, with the other edge being obtained by connecting the end points of the straight lines. Each surface element has its own edges which are not shared with the adjacent surface elements.

The bilinear surface elements are preferably triangular, because triangular surfaces can be fitted particularly well to complex geometries. In such a triangular surface, one of the end points of one straight line of the surface element coincides with one end point of the other straight line, with the third edge of the triangle being formed by the other end points. Alternatively, the bilinear surface element may have a shape with four edges (e.g. a square), so that the end points of the straight lines do not coincide.

If the bilinear surface elements are to be processed in a CAD program, the bilinear surface elements are preferably in the shape of NURBS patches because NURBS patches are invariant against rotation, scale, translation and projection. It should be noted that the option of freeforming NURBS patches of higher degree is abandoned, because the surface elements used are bilinear.

For converting the mesh model into bilinear NURBS patches, the mesh is preferably converted into the IGES format (IGES: Initial Graphics Exchange Specification). The IGES format is an ANSI standard defining a neutral format for data exchange between different CAD, CAM (CAM: Computer Aided Manufacturing) and computer visualizing systems. In this case, the bilinear surface elements conform to IGES #128 entities provided for rational B-spline surfaces.

After breaking the mesh into individual bilinear surface elements, the bilinear surface elements are united to create a closed surface model or a closed solid. For this purpose the opposing edges of two adjacent surface elements are stitched together. In other words, the previously separate edges of the surface elements are combined to a common edge, so that one surface element merges with the other surface element. Since all the surface elements are plane, the surface elements do not merge continuously but form a facetted surface composite.

The above-mentioned facetted surface composite constitutes a surface model of the digitized object. If the surface composite surrounds a finite volume quasi leak-proof, a solid model of the digitized object is formed.

The surface model or solid model can easily be imported into an FE program by CAD-FEM coupling and be linked to form an FE model which may be used for carrying out physical calculations.

The invention has the advantage that curve equations of first order are used for the transition between the numerical and the analytic description of the object data. As compared with reverse engineering that uses curve equations of third or higher order, the complexity of the equation system to be solved is reduced considerably. Even if it is started out from a very fine mesh to create an especially accurate three-dimensional model of the object in question, the time saved by using the less complex equation system is so large that the overall calculation effort is reduced in spite of the high accuracy of the model. Therefore, the invention makes it possible to create an accurate three-dimensional surface model, solid model or FE model of a tangible existing object with relatively low calculation effort.

The invention may be embodied as a method as well as an apparatus or a software product.

Concerning the apparatus, it should be noted that besides a data processor for executing the data processing steps of inputting the mesh model, breaking the mesh model into bilinear surface elements, reuniting the bilinear surface elements to a surface model or solid model, and optionally generating an FE model from the surface model or solid model, there is provided a digitizer for creating the mesh model of the object. Such a digitizer includes all image forming devices such as cameras or X-ray devices that form two-dimensional analogue or digital images from which, in combination with image processing, a three-dimensional mesh can be obtained. Such digitizers also include optical and contact-type scanners which scan the surface of the object to form a three-dimensional point cloud from which, in combination with image processing, a mesh is obtained. Here, it does not matter whether the digitizer and the data processor are separate or whether the digitizer uses the data processor for executing image processing.

It goes without saying that the invention may be embodied as a software product instead of an apparatus, with the above-mentioned data processing being executed by software routines when running on a computer. The software product may be stored on a data carrier or it may be directly loaded into the main storage of the computer.

Further objects, advantages and features of the invention can be gathered from the following detailed description of embodiments and comparative examples under consideration of the attached drawings. In the drawings:

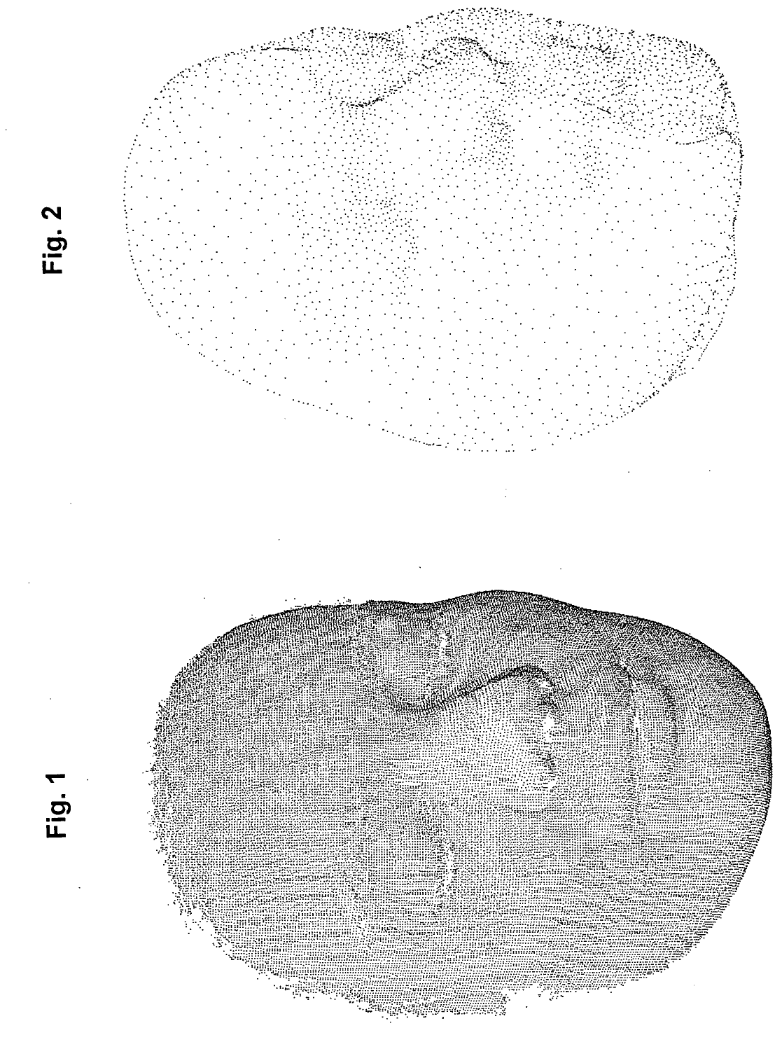

FIG. 1 shows an image of a test person's face in form of a point cloud, the image being digitized by optical scanning;

FIG. 2 shows the point cloud of FIG. 1 after thinning out;

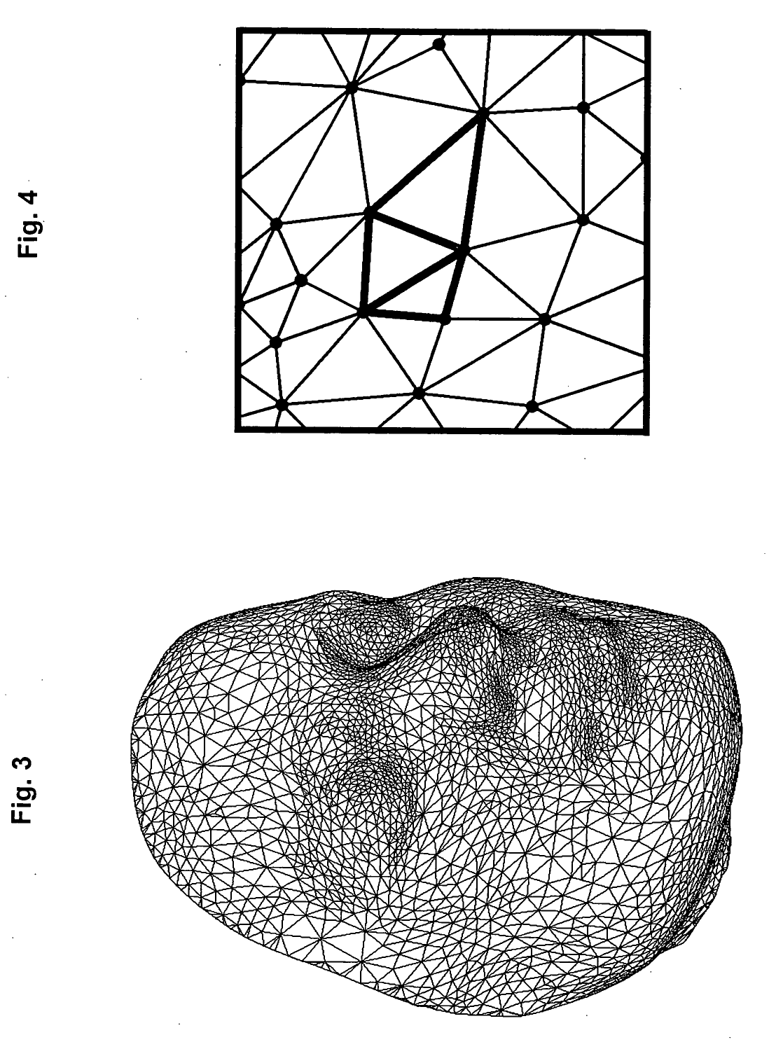

FIG. 3 shows a mesh created from the point cloud of FIG. 2;

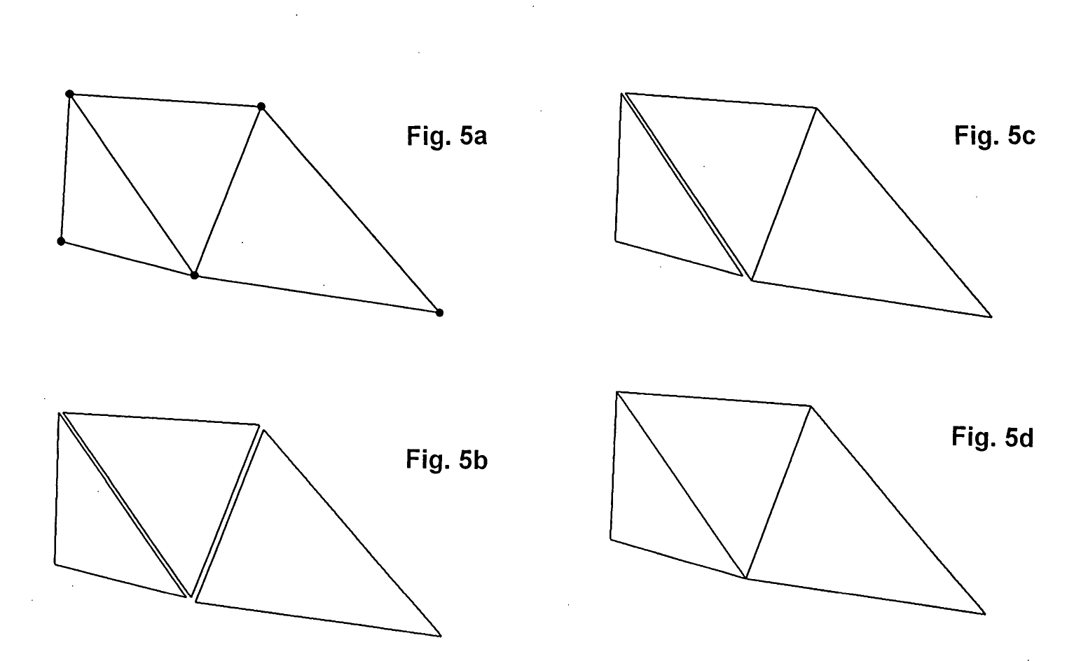

FIG. 4 shows a portion of the mesh shown in FIG. 3;

FIGS. 5a to 5d illustrate a process of forming three bilinear surface elements from three polygons of the portion shown in FIG. 4 and uniting them;

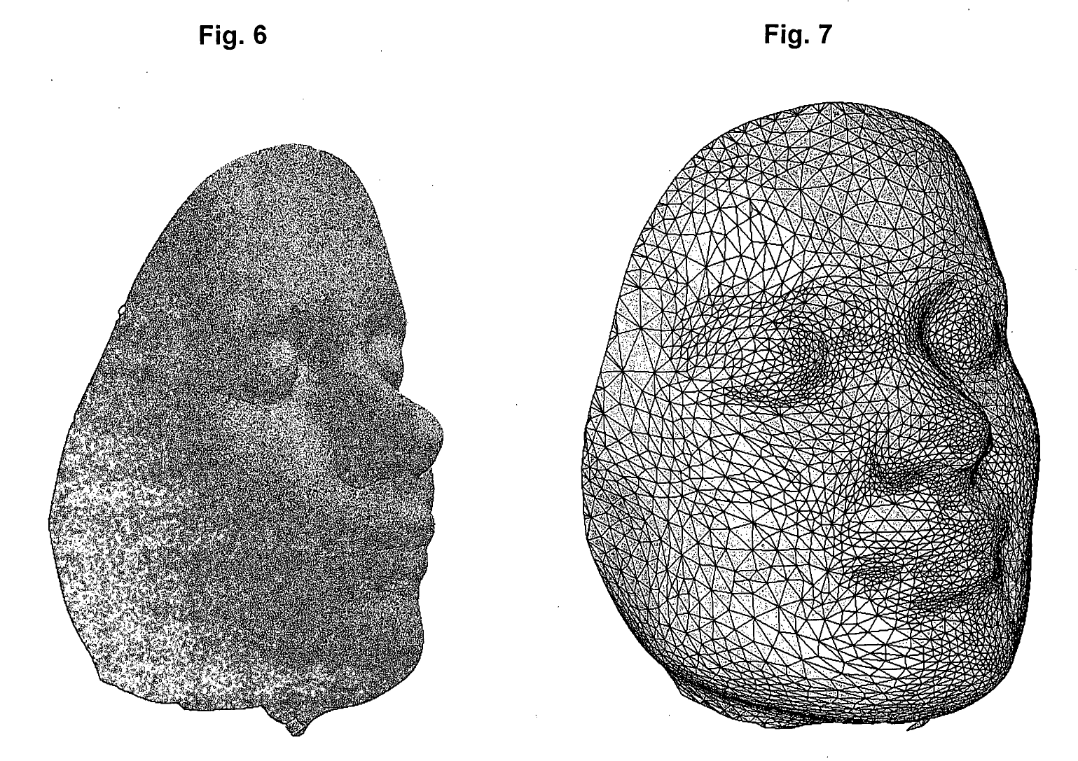

FIG. 6 shows a surface model created from the mesh shown in FIG. 3;

FIG. 7 shows an FE model of facial soft tissue created from the surface model shown in FIG. 6;

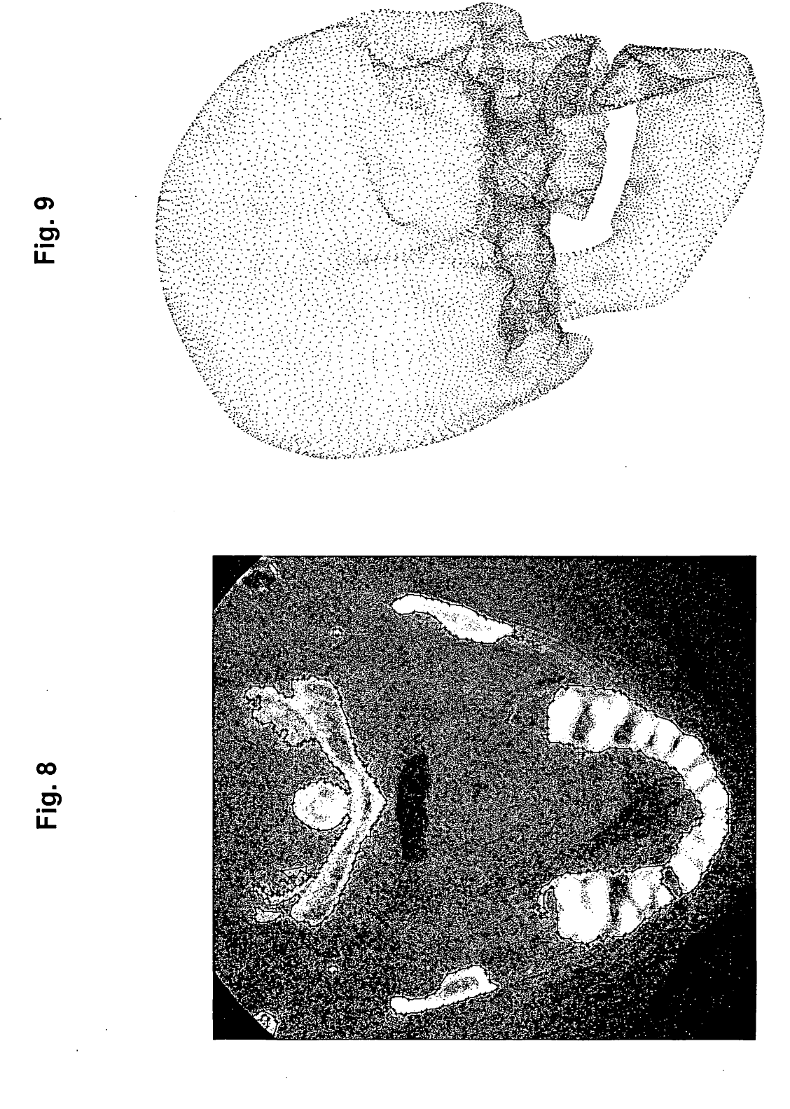

FIG. 8 shows a digitized X-ray tomogram of a human skull in the vicinity of the lower jaw, the skull boundaries being marked and provided with points;

FIG. 9 shows, after homogenizing, a digital image of a skull created from a plurality of tomograms and being in form of a point cloud;

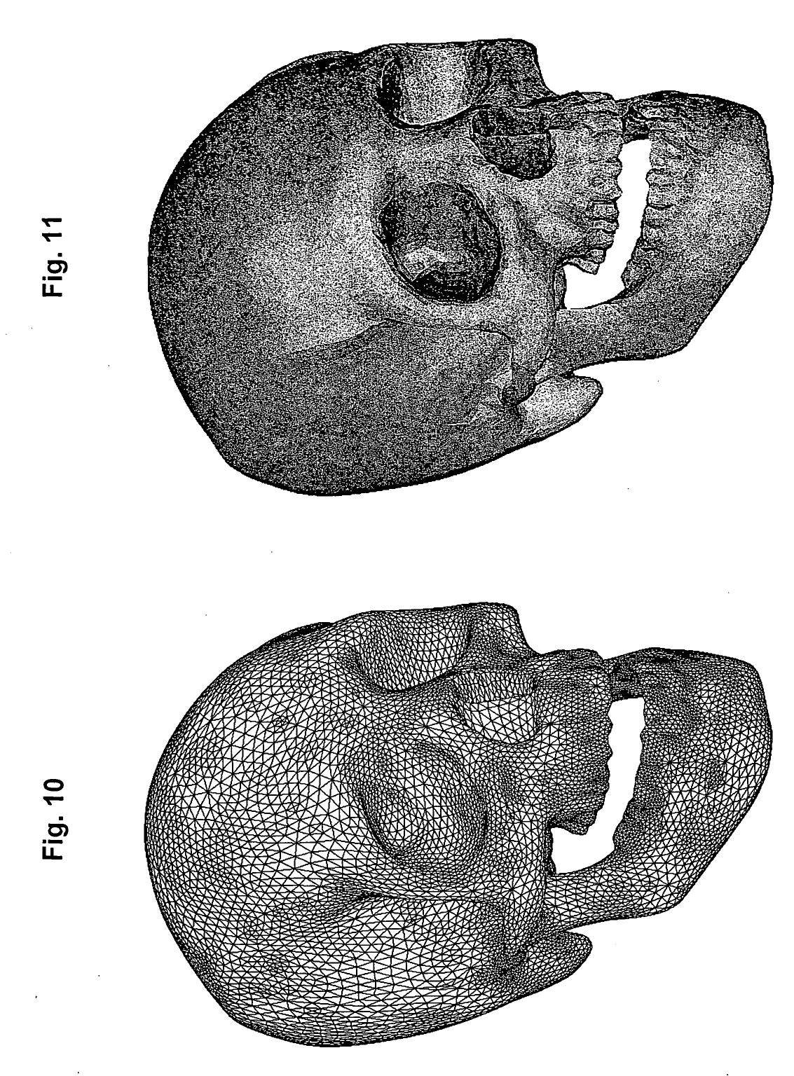

FIG. 10 shows a mesh created from the point cloud of FIG. 9;

FIG. 11 shows a solid model of the skull created from the mesh shown in FIG. 10;

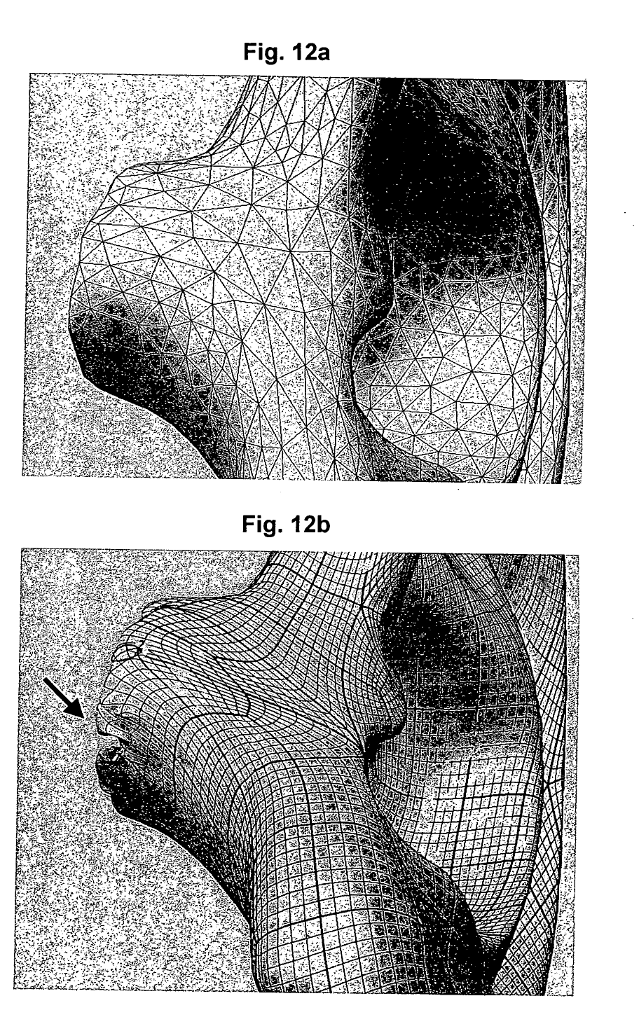

FIG. 12a shows a mesh model of a human ear and FIG. 12b a model made of NURBS patches created from the mesh model by reverse engineering;

FIG. 13 a conventional FE model of facial soft tissue created by reconstruction;

FIG. 14 a conventional FE model of a tooth created by point-based linking of layers;

FIG. 15 a conventional FE model of a human skull created by voxel-based linking of layers; and

FIG. 16 a conventional FE model of a lower jaw created by linking a point cloud.

Referring to FIGS. 1-7, a first embodiment of the invention is described, explaining how a three-dimensional surface model and a FE model of facial soft tissue are created from a digitized image of a test person's face.

A test person's face was digitized by means of a light-coded triangulation method (TRICOLITE™ of the company Steinbichler). For this purpose, a LCD projector threw a series of stripe patterns on the face, which were detected by two CCD cameras at different viewing angles. The complete measurement took about two seconds. Using geometrical analysis (triangulation principle), a three-dimensional image of the facial surface was obtained in form of a point cloud. Further details on the light-coded triangulation method are disclosed in C. Holberg's dissertation (citation in progress) “Erfassung von Gesichtsoberflächen durch ein lichtkodiertes Triangulationsverfahren”, Ludwig-Maximilians-Universität (LMU), Munich (2002).

Then, the point cloud obtained was filtered to get a certain resolution and to safe on redundant data. Specifically, those image points were erased whose location hardly differed from those of the adjacent image points, while those image points were retained whose location differed from those of the adjacent image points more clearly. As a result, the thinned-out point cloud shown in FIG. 2 was obtained, in which the image points are the closer the more the topology of the facial surface changes.

Subsequently, the thinned-out point cloud was imported into the image processing program RapidForm™ (INUS Technology, Inc.) and linked to form a polygon mesh made of triangular polygons. For obtaining a continuous clean polygon mesh, the polygon mesh was freed from crossing, redundant and non-manifold surfaces. In the present case, the option of homogenizing the polygon mesh or increasing or reducing the number of polygon surfaces was not used. The result was the hole-free and cleaned polygon mesh shown in FIG. 3, which was temporarily stored in DXF format.

Subsequently, the polygon mesh stored in the DXF format was imported into the program PolyTrans™ (Okino Computer Graphics) to store the polygon mesh, without further changes, in the neutral IGES format which enables data exchange between different CAD, CAM and computer visualizing systems. Owing to the export as an IGES file, the polygon mesh was broken into bilinear NURBS patches of entity #128. Then, the IGES file obtained was read into the CAD program MechanicalDesktop™ (Autodesk Inc.) where the image of the test person's face was henceforth provided in form of individual surface elements (bilinear NURBS patches) each corresponding to one polygon of the previous polygon mesh. Using the function “Flächen Zusammenheften” (i.e. “Surface Stitching”; other programs use the term “Joining”), the individual surface elements were united to form a surface composite, resulting in the surface model of the test person's face shown in FIG. 6. Subsequently, the surface model was exported by means of the CAD-FEM interface AMACISOUT of the program in SAT format to make the geometry of this surface model accessible for CAD-FEM coupling.

Next, the individual processing steps are explained by reference to FIG. 4 and FIGS. 5a to 5d, which the image data was subjected to at the time of breaking the polygon mesh into the individual surface elements and uniting the surface elements.

FIG. 4 shows a portion of the polygon mesh of FIG. 3 which is taken from an area of the test person's right cheek. In this area, only the three thick polygons are examined whose vertices or nodes are highlighted. These three polygons are illustrated in FIG. 5a without surroundings.

The polygons illustrated in FIG. 5a were converted into the three bilinear NURBS patches shown in FIG. 5b by converting them into the IGES format. As mentioned above, NURBS patches are surface elements each defined by two non-uniform rational B-splines, i.e. by two freeform polynomial curves. Since the initial polygons were plane, the pair of B-splines defining each surface element is not curved either and is thus a curve of first order. According to the invention, the NURBS patches are not numerically described by the vertices of the respective surface element anymore, but analytically by two curves of first order or two straight lines. Since the initial polygons were triangular, the resulting NURBS patches are triangular as well. In other words, one of the end points of one straight line of the NURBS patch coincides with one of the end points of the other straight line with the two straight lines forming two edges of the triangular NURBS patch, while the third edge is obtained by connecting the other end points of the straight lines. Since each NURBS patch is defined by its own pair of linear B-splines, each NURBS patch has its own edges which are not shared with the adjacent surface elements.

As shown in FIG. 5c and FIG. 5d, the individual NURBS patches were united with the adjacent NURBS patches by using the stitching function. The stitching step performs two tasks: First, this function stitches two or more contiguous surfaces to create a surface composite. Second, defects of geometry or topology are corrected, which may occur during conversion due to different internal tolerances and calculation errors. Thus, the stitching step achieves a continuous surface composite that can be used as a surface model.

The surface model of the test person's face shown in FIG. 6 was exported by means of the CAD-FEM interface and imported into the FE program DesignSpace™ of Ansys, Inc. The surface model was treated as a curved surface structure complying with the rules of shell theory. After assigning a uniform thickness, the structure was linked to the three-dimensional FE model of facial soft tissue shown in FIG. 7. Since the defect surfaces had already been erased during cleaning of the polygon mesh, the linking did not make difficulties, so that there were no intersections or overlaps. The FE model had substantially the same high resolution as the polygon mesh and the surface model created in the CAD program. By determining appropriate bearings and loads, this FE model made it possible to calculate deformations, stresses and strains in the facial soft tissue with high resolution. Such calculations may be used for planning plastic surgery and the like.

Next, a second embodiment is described by reference to FIGS. 8-11, explaining how a three-dimensional solid model is created from digitized tomograms of a human skull.

A set of forty-two digital X-ray tomograms was made of a test person's skull by means of computed tomography. Using the image processing program 3D-Dotor™ (Able Software), the boundaries of the skull bone were identified in the tomograms and the marked boundaries were provided with several points. FIG. 8 shows an example of such a tomogram in the vicinity of the lower jaw bone, having boundaries and points.

The points marked in the individual tomograms were combined to a three-dimensional point cloud, the redundant data was removed by filters having a certain resolution, and the remaining point cloud was homogenized. The result was the thinned-out point cloud shown in FIG. 9, in which the image points are the closer the more the topology of the skull surface changes.

Subsequently, the thinned-out point cloud was linked to form a polygon mesh consisting of triangular polygons, and the polygon mesh was cleaned from intersecting, redundant and non-manifold surfaces. Holes that may have occurred were closed again. The resulting polygon mesh is shown in FIG. 10.

Like in the first embodiment, the polygon mesh was imported into the program PolyTrans™ (Okino Computer Graphics) and broken into bilinear NURBS patches of entity #128 to be subsequently stitched together under correction of the errors in geometry or topology that had occurred to form a surface composite. Since the polygon mesh was already free from holes, the surface composite had a continuous surface similar to that of a closed solid, so that the stitching step automatically created a solid model. The completed solid model is shown in FIG. 11 and had substantially the same resolution as the initial polygon mesh, so that it was suitable for a high-resolution FE model. The resulting FE model may be used for simulating the effect of external forces on the skull.

The above embodiments demonstrate that the invention makes it possible to create highly accurate three-dimensional models of tangible existing objects.

The following comparison of the invention with the conventional reverse engineering method provides evidence that the invention is also capable of reducing the calculation effort.

For this purpose, it was started out from a mesh model of the human ear consisting of 3386 triangular polygons. The mesh is shown in FIG. 12a. On the one hand, the mesh was converted as provided by the invention and, on the other hand, it was converted by means of the reverse engineering function of the program RapidForm™ (INUS Technology, Inc.) into NURBS patches of IGES entity #128. In both cases the 3386 polygons were converted into the same number of NURBS patches. In case of the reverse engineering, an additional model having a lower resolution of 232 NURBS patches was prepared as shown in FIG. 12b. The calculation time and the memory requirements of the individual models can be gathered from table 1.

TABLE 1

| | | | Memory | Memory |
|---|---|---|---|---|
| | Number of | Calculation | requirement | requirement |
| | NURBS | time | (uncompressed) | (compressed) |
| Invention | 3386 | 2.9 s | 1.2 MB | 0.4 MB |
| Reverse | 3386 | 1983 s | 29.6 MB | 16.1 MB |
| Engineering | | | | |
| Reverse | 232 | 98 s | 2.0 MB | 1.1 MB |
| Engineering | | | | |

Table 1 shows that the method according to the invention requires considerably less calculation time and memory as compared with the reverse engineering at the same resolution (i.e. the same number of NURBS patches). If the number of NURBS patches is reduced in reverse engineering, the calculation time and the memory requirement are reduced, but geometric inaccuracies have to be put up with. The comparison between FIGS. 12a and 12b shows that reverse engineering produces very smooth surface transitions, but also amounts to a flawed representation, in particular at the periphery of the model (see the arrow in FIG. 12b). The inaccuracies at the periphery are the more noticeable in reverse engineering the more complex the structure to be reproduced is and the lower the resolution (number of NURBS patches produced) is. Similar flaws do not occur in the invention.

Furthermore, it was found that, in particular when the patch layout is automatically generated, the NURBS patches created by reverse engineering result in irregular, defect and twisted CAD surfaces that could not be further processed (for example by means of CAD-FEM coupling). Since the manual generation of patch layouts is time-consuming, error-prone and can usually only be accomplished by a skilled person, reverse engineering is not a practical solution for creating FE models from digitized anatomical structures such as the ear shown in FIG. 12a.

It follows that the invention is not only capable of providing a highly accurate time-saving and memory-saving alternative for reverse engineering, but develops new applications in the field of modeling highly complex objects such as in the field of biotechnology, which were not accessible up to date for reverse engineering or other conventional methods.

1-15. (canceled)

16. A method of creating a three-dimensional model of a tangible existing object, the method comprising:
digitizing the object to create a polygon mesh of the object;
breaking the polygon mesh into separate bilinear NURBS patches; and
uniting the bilinear NURBS patches to form a continuous surface composite of the bilinear NURBS patches to obtain a surface model or solid model of the object.

17. A method according to claim 16, wherein the step of digitizing comprises obtaining the polygon mesh from point cloud data of the object.

18. A method according to claim 16, wherein the breaking step comprises breaking the polygon mesh into triangular bilinear NURBS patches.

19. A method according to claim 16, further comprising the step generating a finite element model from the surface model or solid model.

20. A method according to claim 16, wherein said uniting comprises stitching the bilinear NURBS patches together.

21. An apparatus for creating a three-dimensional model of a tangible existing object, the apparatus comprising:
a digitizer for creating a polygon mesh of the object; and
a data processor for executing the data processing steps of reading the polygon mesh; breaking the polygon mesh into separate bilinear NURBS patches; and uniting the bilinear NURBS patches to form a continuous surface composite of the bilinear NURBS patches to obtain a surface model or solid model of the object.

22. An apparatus according to claim 21, wherein the data processor generates a finite element model of the object from the surface model or solid model.

23. An apparatus according to claim 21, wherein the data processing steps are executed in the data processor by software routines.

24. An apparatus according to claim 21, wherein said uniting comprises stitching the bilinear NURBS patches together.

25. A computer program embodied on a computer-readable medium, said computer program for creating a three-dimensional model of a tangible existing object, the computer program executing the following data processing steps by software routines when it runs on a computer: reading a polygon mesh of the object; breaking the polygon mesh into separate bilinear NURBS patches; and uniting the NURBS patches to form a continuous surface composite of the bilinear NURBS patches to obtain a surface model or solid model of the object.

26. A computer program according to claim 25, which creates the separate bilinear NURBS patches by breaking the polygon mesh into the bilinear NURBS patches through conversion into IGES format.

27. A computer program according to claim 26, wherein the polygon mesh converted into the IGES format comprises exclusively surface elements of IGES entity #128.

28. A computer program according to claim 25, which generates a finite element model of the object from the surface model or solid model through CAD-FEM coupling.

29. A computer program according to claim 25, wherein said uniting comprises stitching bilinear NURBS patches together.
